(19) United States
(12) Patent Application Publication
(10) Pub. No.: US 2011/0223516 A1
(43) Pub. Date: Sep. 15, 2011

(54) HIGH-TEMPERATURE FUEL CELL STACK, AND PRODUCTION THEREOF

(75) Inventors: Helmut Ringel, Niederzier (DE); Uwe Reisgen, Eschweiler (DE)

(73) Assignee: Forschungszentrum Juelich GmbH, Juelich (DE)

(21) Appl. No.: 12/734,344

(22) PCT Filed: Oct. 22, 2008
(86) PCT No.: PCT/DE2008/001725

§ 371 Date: Apr. 26, 2010

(30) Foreign Application Priority Data
Nov. 9, 2007 (DE) 10 2007 053 879.2

(51) Int. Cl. H01M 8/24; H01M 8/00

(52) U.S. Cl. 429/468; 429/535

(57) ABSTRACT

A cassette for a high-temperature fuel cell stack, comprising at least one fuel cell including an anode, a cathode, and an electrolyte, and a metal cell frame which surrounds the fuel cell peripherally, wherein the metal cell frame has two sections, these being an inner thin compensating frame that contacts the fuel cell and a thicker, rigid outer frame which is provided for contacting the interconnector. The inner compensating frame comprises a peripheral bead at room temperature, which entirely disappears at temperatures between 980° C. and 1100° C., as a result of the prevailing stresses. The bead has special relief functions. It is significant that this special function of the formed bead is exclusively achieved by way of the warping in the compensating metal sheet or the compensating film, and is formed solely by way of the joining sequence applied, which is to say only in combination with the joining process employed. In contrast, a component that already has a bead prior to the joining process would also be able to compensate for stresses, but not to the same extent as a bead produced using this joining process.

The invention relates to a high-temperature fuel cell system, and particularly to a fuel cell system comprising oxide ceramic electrolytes (SOFC=solid oxide fuel cell), and to a method for the production thereof.

### STATE OF THE ART

Fuel cells are sources of electric power, in which chemical energy is converted into electric energy by the electrochemical oxidation of an easily oxidizable substance, typically hydrogen by oxygen. Given the low voltage that each individual fuel cell supplies, a large number of fuel cells are generally connected in series, using what are known as interconnectors, in order to increase the electric output, and the fuel cells are joined and sealed in an electrically insulating manner by way of solder glass (fuel cell stack). The individual cell levels, which is to say the ceramic cells comprising the metal interconnector, are also referred to as cassettes.

The operating temperature of a high-temperature fuel cell stack (SOFC stack) ranges between 700 and 800° C. An SOFC stack having planar fuel cells typically comprises ceramic cells and metal interconnectors. To this end, the ceramic cell is installed in a metal frame, which in turn is connected to the interconnector.

In [1], for example, the production of a fuel cell stack is described, wherein individual assemblies are first joined to form what is referred to as cassettes, and these are subsequently assembled to form the actual stack. The first step consists of brazing the ceramic cell into what is known as a window plate. Reactive air brazing (RAB) is employed for this process of joining the metal and ceramic. In the second step, the brazed composite is welded to the interconnector made of ferritic chromium steel, by way of laser welding, to form a cassette. Laser welding is intended to minimize the introduction of heat and attendant stresses in the composite. Since the ceramic cell has little plasticity, care must be taken during welding that the thermally induced residual stresses are minimized. Otherwise, the residual stresses may result in warping of the finished brazed composite, or in lasting damage and breakage of the cell. After a leakage test, the cassettes are combined in an electrically insulating manner in a furnace at approximately 850° C. to form a stack, using solder glass.

The ceramic cell generally comprises nickel cermet, the major component being zirconium oxide and minor components being nickel oxide and/or nickel. Nickel cermet has relatively uniform thermal expansion in the temperature range of room temperature to 1000° C., which means it has a temperature-independent thermal coefficient of expansion of α=12×10⁻⁶ K⁻¹. In contrast, the sheet metal frame is generally made of ferritic chromium steel, and thus the relative thermal expansion increases with the temperature. The coefficient of expansion increases from α=11×10⁻⁶ K⁻¹ at low temperatures to α=14×10⁻⁶ K⁻¹ at 1000° C. Typical chromium steel includes iron, comprising, for example, approximately 22% Cr and other trace elements.

In addition, the coefficient of expansion of the solder glass used for sealing the cells between each other generally cannot be exactly matched to the thermal coefficient of expansion of the steel.

The problem with such a cell design is that the ceramic cell is very brittle. This means that it can transmit only small forces and, in particular, does not withstand any tensile or bending stresses. In addition, the cell is generally relatively thin and has a large surface area. The typical cell density varies between 0.5 and 1.5 mm, and the surface extends to as large as 200×200 mm². In contrast, the metal frame and the interconnector have a considerably more stable design. As a result, the ceramic cell is usually subject to a high risk of breakage due to the fundamental differences in the thermal expansion of the cell and interconnector and the frame, specifically due to the temperature differences in the SOFC stack occurring during heating and cooling.

In addition, a latent risk of breakage exists in the solder glass joint between the individual cassettes, since the solder glass is brittle in principle and thermal stresses, as mentioned above, can develop between the individual material levels.

### PROBLEM AND SOLUTION

It is an object of the invention is to create a high-temperature fuel cell stack in which the risk of breakage mentioned above can be significantly reduced. It is also an object of the invention to provide a method for producing such a high-temperature fuel cell stack.

The objects of the invention are achieved by a method for producing a cassette for a high-temperature fuel cell stack according to the main claim and by a high-temperature fuel cell stack according to the additional independent claim. Advantageous embodiments of the method and of the system are apparent from the respective dependent claims.

### SUBJECT MATTER OF THE INVENTION

The method according to the invention for producing a cassette for a high-temperature fuel cell stack notably comprises two steps, in which a cell is installed into a metal frame.

The basic idea of the invention is that while the connection between the cell and the metal frame of the cell as a unit of the interconnector must be designed to be gas-tight, it still must be sufficiently flexible to ensure that the otherwise common risk of breakage is reduced, or even eliminated, despite fluctuating temperature loads and consequently fluctuating expansions of the different materials involved.

In the method according to the invention, an individual fuel cell is installed into a metal frame, which comprises at least two sheet metal regions, these being an inner thin sheet metal frame (compensating frame) and a thicker outer sheet metal frame (outer frame). This frame advantageously has a two-piece design, but can also be designed as one piece. Production as one piece can be achieved, for example, by way of casting, hot press molding, or hot rolling.

During assembly, in the case of the two-piece variant of the metal frame, in a first step, the thin sheet metal of the compensating frame is joined to the thicker sheet metal of the outer frame. This joining can be established by welding, for example, or the metal sheets are produced together using a stamping operation. In a second step, the ceramic fuel cell is subsequently joined to the thin sheet metal of the metal frame at a high temperature of approximately 1000° C. This process can be carried out by way of high-temperature brazing, for example.

As the cell/frame composite cools down from this high temperature to room temperature, both the cell and the frame shrink, the metal frame doing so more strongly than the cell. This means that, during cooling, compressive stresses are introduced into the cell. However, these are low, since the inner, very thin-walled part of the frame is initially very soft at 1000° C. to as low as 700° C., and is hardly capable of transmitting forces. During further cooling, this usually results in bending of the thin-walled part (compensating frame) of the metal frame so as to produce an indentation in the form of a bead, which surrounds the cell peripherally. This naturally developing bead shape, which is optimally adapted to the cell, in the peripheral sheet metal frame, together with the minor compressive stresses in the fuel cell, protect the cell from the introduction of excessive tensile stresses during operation of the fuel cell stack. As a result, the fuel cell is subject to a reduced risk of breakage. Since the bead develops naturally during cooling, it is always optimally adapted to the situation of the individual fuel cell.

It is significant that the relief function which this bead assumes is exclusively achieved by way of this warping in the compensating metal sheet, or the compensating film, and is formed solely by the joining sequence that is applied, which is to say only in combination with the joining process that is employed.

In contrast, a component that already has a bead prior to the joining process would also be able to compensate for stresses, but not to the same extent as the ideal bead according to the invention, because this bead is naturally ideally adapted to the cell. The bead according to the invention therefore usually adapts ideally to the actually occurring stresses everywhere.

In an advantageous embodiment, a spacer frame is provided during assembly of the cassettes, which is a stiff or very rigid component.

During further assembly, an interconnector subsequently is joined to the spacer frame, which also ensures electrical contact with the anode by way of a nickel mesh.

Another advantage, in terms of producing an SOFC stack, is that the transmission of force into the solder glass layers between the individual cassette layers is also reduced for the same reason, thereby significantly reducing the risk of breakage in the solder glass.

### SPECIFIC DESCRIPTION

The invention will be described in more detail hereinafter based on several figures, without thereby limiting the scope of the present invention available to the person skilled in the art.

In the figures, the following meanings apply:
A=1+2+3
1 Cathode
2 Electrolyte
3 Anode or anode substrate.
4 Brazed seal, RAB filler or also solder glass
B=5+6 (one- or multi-piece cell frame)
5 Compensating frame=thin-walled metal sheet
6 Outer frame=thick metal sheet
7 Bead in the compensating metal sheet
8 Rigid spacer or spacer frame
9 Interconnector
10 Electric contacting, for example by way of nickel wire mesh
11 Solder glass seal
12 Anode region
13 Cathode region
14 Window plate

FIG. 1 is a schematic illustration of a cross-section of the peripheral metal cell frame A in the two-piece or multi-piece design. The cell frame comprises a film-like thin compensating frame 5 and a slightly thicker outer frame 6, which abuts a rigid spacer frame 8. In order to produce the frame composite, first the thin compensating frame 5 is welded to the thicker outer frame 6 and the spacer 8 at room temperature, by laser welding or the like. The compensating frame 5 is made, for example, of chromium steel having a sheet metal thickness of 0.05 to 0.1 mm. The outer frame 6 is made, for example, of chromium steel having a sheet metal thickness of more than 0.4 mm, and the spacer 8 is made, for example, of chromium steel having a sheet metal thickness of approximately 1 mm.

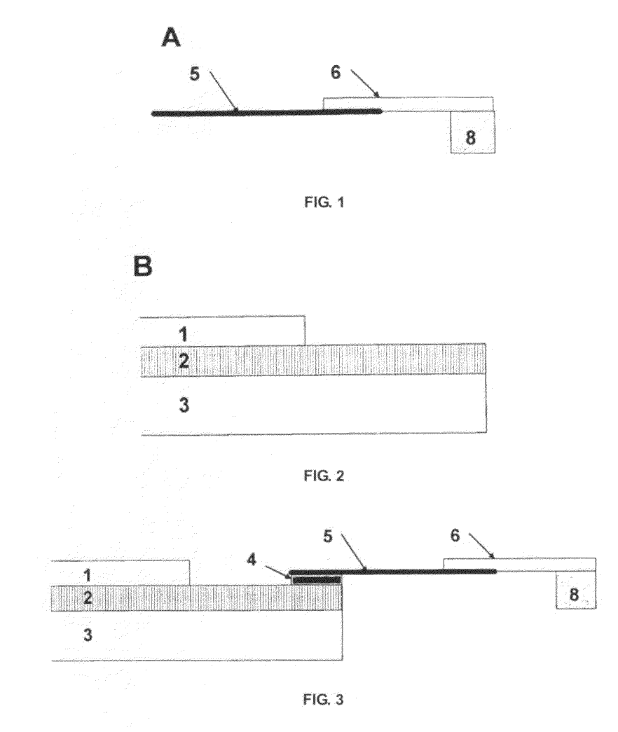

FIG. 2 shows a section of a ceramic cell B, comprising a supporting anode substrate 3, the electrolyte 2, and the cathode 1.

After welding the frame composite A together, it is brazed to the cell B at a temperature of 980 to 1100° C., by reactive air brazing or the like, using RAB filler 4, as is apparent from FIG. 3.

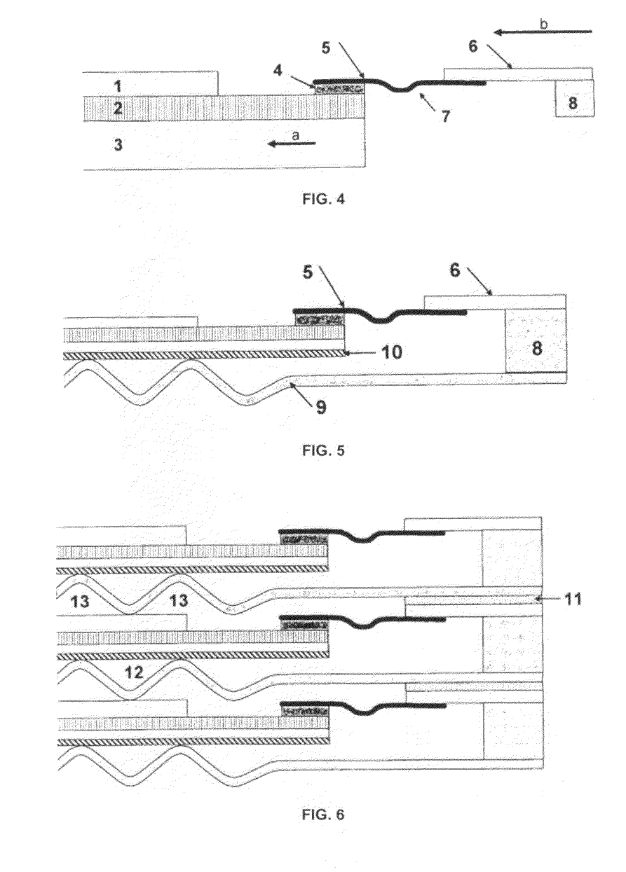

As the composite 1 cools, the different thermal expansions of the cell B and the chromium steel of the cell frame A, as indicated by the arrows a and b, produce a bead 7 in the thin-walled part (compensating frame) of the metal cell frame. The bead generally runs peripherally around the entire cell, and a cross-section thereof is shown in FIG. 4.

FIG. 5 shows the section of a cassette according to the invention in a fuel cell unit comprising the composite of the cell B plus the cell frame A (including the spacer 8) and the interconnector 9. When composite A and the interconnector 9 are welded together, the interconnector 9 is at the same time electrically contacted with the anode substrate 3 by way of a nickel wire mesh 10.

FIG. 6 shows a section of a fuel cell stack produced by stacking a series of cassettes produced according to the invention. The individual cassettes are joined together using solder glass 11 such that, in each case, the interconnector 9 is electrically contacted with the cathode 1 of an adjoining cassette and the cathode region 13 is sealed. Thereafter, the inflow and outflow lines of the anode region 12 are sealed (not shown in FIG. 6).

Literature cited in this application:
[1] U. Reisgen, W. Behr, A. Cramer, S.-M. Groβ, T. Koppitz, W. Mertens, J. Remmel, F.-J. Wetzel; in “Die Hochtemperaturbrennstoffzelle—eine fügetechnische Herausforderung” (The high-temperature fuel cell—a challenge for joining technology); Schweissen and Schneiden 2006, DVS Reports Volume 240, Düsseldorf 2006, pages 216-221

1. A method for producing a cassette for a high-temperature fuel cell, comprising at least one fuel cell having an anode, cathode, and electrolyte, and a metal cell frame, comprising the following steps:
joining the one-piece or multi-piece metal cell frame, comprising an inner compensating region and a rigid outer region, to the fuel cell,
cooling the cell frame/fuel cell composite, so that a peripheral bead is formed in a part of the metal frame.

2. The method according to claim 1, wherein the metal cell frame is produced by stamping, casting, hot press molding, or hot rolling.

3. The method according to claim 1, wherein the metal frame is first comprised of at least two parts, a first compensating metal sheet being joined to a second rigid outer metal sheet, and the compensating metal sheet being thinner than the outer rigid metal sheet.

4. The method according to claim 3, wherein the compensating metal sheet and the outer rigid metal sheet are joined at temperatures below 50° C.

5. The method according to claim 4, wherein the two parts are joined by welding.

6. A method according to claim 1, wherein the cell frame is joined to the fuel cell at temperatures between 980° C. and 1100° C.

7. A method according to claim 1, wherein chromium steel is used as the material for the compensating region.

8. A method according to claim 1, wherein a material having a thickness between 0.05 and 0.1 mm is used for the compensating region.

9. A method according to claim 1, wherein chromium steel is used as the material for the outer region.

10. A method according to claim 1, wherein a material having a layer thickness of more than 0.4 mm is used for the outer region.

11. A method according to claim 1, wherein the metal cell frame is joined to a spacer frame.

12. The method according to claim 11, wherein, after joining the metal cell frame to the fuel cell, the spacer is joined to an interconnector.

13. The method according to claim 12, wherein at the same time the interconnector is electrically contacted with the anode of the fuel cell.

14. The method according to claim 13, wherein a nickel wire mesh is introduced between the interconnector and the anode for electric contacting.

15. A cassette for a high-temperature fuel cell stack, produced according to claim 1, comprising at least one fuel cell including an anode, cathode, and electrolyte, and a metal cell frame surrounding the fuel cell peripherally:
the metal cell frame has two regions, these being an inner thin compensating frame contacting the fuel cell, and a thicker rigid outer frame for contacting the interconnector; and
the inner compensating frame has a peripheral bead at room temperature, which entirely disappears at temperatures between 980° C. and 1100° C. due to the prevailing stresses.

16. The cassette according to claim 15, wherein the compensating frame is further disposed on the rigid outer frame.

17. The cassette according to claim 16, wherein an interconnector is disposed on the compensating frame.

18. The method according to claim 3, wherein the compensating metal sheet and the outer rigid metal sheet are joined at room temperature.
